(19) United States
(12) Patent Application Publication
(10) Pub. No.: US 2014/0351416 A1
(43) Pub. Date: Nov. 27, 2014

(54) Characterizing Statistical Time-Bounded Incident Management Systems

(71) Applicant: International Business Machines Corporation, Armonk, NY (US)

(72) Inventors: Carolina Santos Andrade, Campina (BR); Ana Paula Appel, Sao Paulo (BR); Victor Fernades Cavalcante, Campinas (BR); Rogerio Abreu De Paula, Sao Paulo (BR); Claudio Santos Pinhanez, Sao Paulo (BR)

(73) Assignee: International Business Machines Corporation, Armonk, NY (US)

(21) Appl. No.: 13/969,890

(22) Filed: Aug. 19, 2013

Related U.S. Application Data
(63) Continuation of application No. 13/901,722, filed on May 24, 2013.

(51) Int. Cl. H04L 12/26

(52) U.S. Cl. CPC H04L 43/04
USPC 709/224

(57) ABSTRACT

Systems and articles of manufacture for characterizing statistical time-bounded incident management systems include generating an expected distribution of multiple work requests in an incident management system across multiple characterization classes based on a target service level agreement for each of the multiple work requests and one or more probability distribution values, analyzing the multiple work requests in the incident management system to determine an actual distribution of the multiple work requests across the multiple characterization classes, and comparing the expected distribution of the multiple work requests to the actual distribution of the multiple work requests for each of the multiple characterization classes to characterize performance of the incident management system.

### CROSS-REFERENCE TO RELATED APPLICATIONS

This application is a continuation of U.S. patent application Ser. No. 13/901,722, filed May 24, 2013, and incorporated by reference herein.

Also, the present application is related to U.S. patent application entitled “Characterizing Time-Bounded Incident Management Systems,” identified by Ser. No. 13/553,922 and filed on Jul. 20, 2012, the disclosure of which is incorporated by reference herein in its entirety.

### FIELD OF THE INVENTION

Embodiments of the invention generally relate to information technology (IT), and, more particularly, to time-bounded incident management systems.

### BACKGROUND

Systems to deliver and provision services have become increasingly important engines of the global economy, where services are increasingly becoming the dominant mode of production. To meet those demands, an increasing number of enterprises have established mass-scale, complex systems to deliver services using factory-like production methods. Such systems can include hundreds (or possibly thousands) of service workers spread across multiple geographic locations and time-zones.

Additionally, such systems are often structured in sub-organizations or departments that handle different support and maintenance activities related to the IT infrastructures of their customers. One such sub-organization includes a sub-organization that handles incidents and is responsible for tackling urgent and critical tasks required to maintain customers' IT infrastructure running. These sub-organizations are referred to as time-bounded incident management (TBIM) systems.

TBIM systems typically require clearly defined incident response times. The ability to collect, process, and analyze performance data in order to provide metrics for effective management is critical for the success of TBIM systems. However, challenges exist in evaluating the performance and quality of TBIM systems based on ticket data, as well as in diagnosing problems and issues based on ticket data.

### SUMMARY

In one aspect of the present invention, techniques for characterizing statistical time-bounded incident management systems are provided. An exemplary computer-implemented method can include steps of generating an expected distribution of multiple work requests in an incident management system across multiple characterization classes based on a target service level agreement for each of the multiple work requests and one or more probability distribution values, analyzing the multiple work requests in incident management system to determine an actual distribution of the multiple work requests across the multiple characterization classes, and comparing the expected distribution of the multiple work requests to the actual distribution of the multiple work requests for each of the multiple characterization classes to characterize performance of the incident management system.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example characterization graph, according to an embodiment of the present invention;

FIG. 2 is a block diagram illustrating an example embodiment, according to an aspect of the invention;

FIG. 3 is a flow diagram illustrating techniques according to an embodiment of the invention; and

FIG. 4 is a system diagram of an exemplary computer system on which at least one embodiment of the invention can be implemented.

### DETAILED DESCRIPTION

As described herein, an aspect of the present invention includes characterizing statistical time-bounded incident management systems. At least one embodiment of the invention includes providing and implementing an analytical technique, referred to herein as a Workload Profile Diagnosis (WPD) method, to evaluate the performance and quality of incident management systems in IT service factories.

Based on the normalization of ticket assignment delay and resolution time by a ticket's respective service level agreement (SLA), the WPD method computes and plots the spreading of ticket data on a log-log chart. By comparing the actual and desired distribution values in specific areas, the WPD method diagnoses specific problems and issues in the performance of incident management systems such as, for example, resource and skill allocation and abnormal behavior. The WPD method also identifies opportunities for automated resolution and/or assignment of tickets (also referred to herein as work requests), as well as increases or decreases in the resources and skills needed. Additionally, at least one embodiment of the invention includes producing a WPD representation that characterizes the performance of TB IM systems, helping to diagnose issues (resource and skill allocation, abnormal behavior, ticket characteristics, etc.).

As further described herein, given a desired ticket distribution (DTD) at least one embodiment of the invention includes defining the WPD method as a method to compare the actual values of the actual ticket distribution in noted areas of interest with the desired (or target) values of the DTD. The desired (or target) values can be estimated based on a suitable probability distribution, taking into account desired service level agreements. To standardize the comparison, at least one embodiment of the invention includes denominating an area of interest as a problem or an issue based on specific deviations. For example, a problem occurs when the absolute difference between the desired and the actual value is greater than 100% of the desired value. In another example, an issue occurs when the absolute difference between the desired and the actual value is between 50% and 100% of the desired value. Such thresholds as noted in the above examples can be determined based on historical data and/or experience.

At least one embodiment of the invention includes generating and analyzing a work profile chart (WPC). This can include, for example, plotting the ticket data of a service pool on a two-dimensional log-log graphic where the axes correspond to the normalized assignment and resolution times. Accordingly, the density map of this plot is referred to as the WPC of the service pool. Further, at least one embodiment of the invention includes taking the WPC of a service pool and systematically examining the concentration levels in different areas (also referred to herein as characterization classes). As additionally detailed herein, high or low concentration of tickets in a particular area corresponds to a set of specific characteristics likely to describe the reality of a service pool.

To construct the WPC, at least one embodiment of the invention includes normalizing the tickets' assignment delays and resolution times by their respective SLA duration, and plotting the information on a normalized assignment delay and resolution time space. A logarithmic version of that space can be considered and a corresponding density matrix computed by dividing space into smaller bins (that is, a grid) and counting the number of tickets within each bin. Accordingly, in at least one embodiment of the invention, the WPC is the depiction of the log-log density matrix with a grey scale associated to different ranges of ticket concentration.

Additionally, analyzing a WPC based on visual inspection of the concentration of tickets in denoted areas of interest can include the following. The group of tickets corresponding to the service pool being analyzed in a certain period of time is selected, and the associated workload profile density matrix and WPC are computed. The primary concentrations of tickets in the WPC are determined visually or through computational inspection of the workload profile density matrix. As referred to above, a computation inspection refers to an inspection process conducted by pattern recognition and automated application of characterization rules. Also, each of the noted concentrations of tickets can be mapped to one of the denoted areas of interest and the respective characterization can be applied to the system or component.

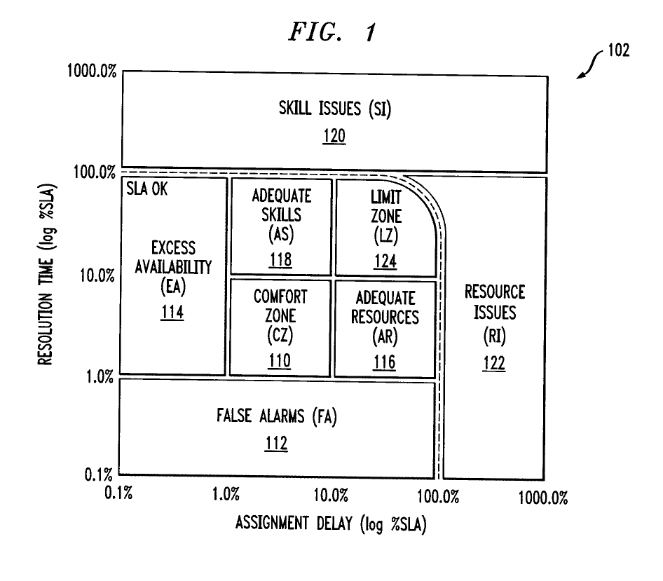

FIG. 1 is a diagram illustrating an example characterization graph 102, according to an embodiment of the present invention. By way of illustration, FIG. 1 depicts exemplary areas of ticket concentration in an example embodiment of the invention. Specifically, consider the area in the illustrated characterization graph 102 comprising between 0.1% and 1000% of both the log of the assignment delay (X axis) and the log of resolution time (Y axis). The characterization graph 102 is conceptually divided into eight areas, some of which roughly corresponding to the area in which tickets that meet SLA are plotted, as identified in FIG. 1 by the areas bounded within the dashed line.

Additionally, the above-noted eight areas, each corresponding to specific issues, can be detailed as follows:
Comfort Zone (CZ) 110: this area contains tickets that are quickly assigned and resolved. A high concentration of tickets in the comfort zone 110 indicates that the TBIM system is working smoothly and comfortably, with most tickets easily finding resources to work on them and the corresponding issues being solved without much difficulty.
False Alarms (FA) 112: this area corresponds to tickets easily recognized as false alarms and therefore easily dismissible. A high concentration of tickets here suggests that the performance can be greatly improved by better ticket automation or filtering approaches.
Excess Availability (EA) 114: this area, covering the left side of the SLA OK zone [0.1%-1%, 1.0%-100%] contains tickets which are quickly assigned but whose resolution takes some time. A high concentration of tickets in this area indicates that there are often system administrators (sys-admins) ready to immediately start working on tickets as soon as the tickets arrived and are dispatched. In other words, there are often too many sys-admins available. These tickets are also good candidates for automatic dispatching, possibly using pattern recognition and machine learning methods.
Adequate Resources (AR) 116 this area covers the region to the right of Comfort Zone [10%400%, 1%-10%], containing tickets that meet their SLAs and to which assignments are not immediate but are quickly resolved. A high concentration of tickets in this area indicates that resources are not always immediately available, and therefore assignment takes some time, but such time does not compromise the SLA attainment. Systems with heavy concentration in this area have good levels of resource utilization.
Adequate Skills (AS) 118: this area corresponds to the region situated on the top of the comfort zone [1%-10%, 10%400%] and includes tickets which meet their SLAs. Tickets in this area require a good amount of effort for resolution and therefore adequate skill matching is often critical. A high concentration of tickets here indicates that resolution tasks can be time-consuming and that the SLAs cannot be made tighter without adding more skilled resources to the pool.
Limit Zone (LZ) 124: this area corresponds to the area situated on the top-right quadrant of the comfort zone [10%-10%, 10%-100%], and includes tickets which meet their SLAs and that take some time both to be assigned and to be solved. A high concentration of tickets in this area often means that the system is running close to its limit, and therefore, resources and skills are being optimally used but with little or no slack. However, heavy concentrations of tickets in this area can also indicate a high susceptibility to breakdown when unexpectedly heavy concentrations of incidents occur.
Skill Issues (SI) 120: this area covers tickets whose resolution required more than 100% of the SLA time. Tickets here are lost because the resource assigned does not have the right skills to complete the task on time. A heavy concentration of tickets here usually indicates serious resource skills issues.
Resource Issues (RI) 122: this area covers tickets that do not meet their SLA but whose resolution takes less than 100% of the SLA time. In other words, tickets in this area can be saved if they are assigned without much delay. A heavy concentration of tickets here often indicates that the service pool is not appropriately dimensioned or has dispatching problems.

As noted herein, at least one embodiment of the invention generates and/or utilizes a desired ticket distribution (DTD) to define a baseline to use as a reference to perform a diagnosis of WPCs. Accordingly, given a target SLA and considering a probability distribution, for each area of interest, an expected ticket distribution is computed based on the adopted probability distribution using the one or more statistical parameters. By way of example, a probability distribution can include a log-normal distribution, and statistical parameters can include mean and standard deviation of assignment delay and resolution time variables. Further, a target SLA can include, for example, a target percentage value for the sum of the ticket percentile of the “Resource Issues” and “Skills Issues” areas of interest.

Additionally, given an input of an SLA target, a DTD method according to at least one embodiment of the invention can generate an output of an expected distribution of tickets in each denoted area (such as the areas depicted in the FIG. 1 WPC). Carrying out a DTD method can, by way of illustration, include the following steps. Variables μₐ, σₐ, μᵣ, σᵣ are initialized with appropriate values from a finite list of candidate values, and ticket distribution (TD) is referred to as (μₐ, σₐ, μᵣ, σᵣ). As used herein, μₐ, σₛ represent the mean and standard deviation of the assignment delay variable, respectively, and μᵣ, σᵣ, represent the mean and standard deviation of the resolution time variable, respectively. Also, by way merely of example, appropriate values (as noted above) might include σₐ=2μₐ and σᵣ=2μᵣ, where σₐ and σᵣ are values up to 100%. Accordingly, an example range of appropriate values might include values greater than 0 and limited to 100.

Also, at least one embodiment of the invention includes setting min_slagap=slagap=100%. As used herein, min_sla_gap and sla_gap are auxiliary variables to control and verify conditions on the search procedure. Further, let P_{SI} and P_{RI} be the values (for example, percentages) obtained corresponding to the Skills Issues (SI) and Resource Issues (RI) areas of interest, respectively, and accordingly, slagap=|sla_target−(P_{SI}+P_{RI})| can be computed.

If sla_gap<min_sla_gap, min_sla_gap is updated with sla_gap and the current values computed to the denoted areas of interest (for example, FA, EA, CZ, AR, AS, LZ, RI, and SI) are stored as the current best or most desirable distribution. If min_sla_gap<the precision required, or if all possible values of μₐ, σₐ, μᵣ, and σᵣ were enumerated, at least one embodiment of the invention includes restoring and returning the best or most desirable distribution found to that point as the desired result. Otherwise, μₐ, σₐ, μᵣ, and (yᵣ are updated with a new combination of values and ticket distribution (TD) can be re-identified as (μₐ, σₐ, μᵣ, σᵣ).

In conjunction with the above-noted techniques, a TD method, given inputs of (μₐ, σₐ, μᵣ, σᵣ), can include the following steps. The parameters for assignment and resolution are computed as:

$$m = \frac{1}{2} ln ( \frac{{μ}^{4}}{{σ}^{2} + {μ}^{2}} ) and {s}^{2} = ln ( \frac{{σ}^{2} + {μ}^{2}}{{μ}^{2}} ) .$$

Further, the probability associated to each area of interest is computed as:

P(X in [a₁,b₁]*[a₂,b₂])=(F(b₁)−(F(a₁))*(G(b₂)−G(a₂)),

where [a₁, b₁] and [a₂, b₂] define, respectively, the ranges of assignment delay and resolution time; F(G) corresponds to the cumulative distribution function, and parameters m and s² correspond to assignment delay and resolution time, respectively. In continuation of the TD method, the generated ticket distribution is returned for each area.

At least one embodiment of the invention can additionally include a workload profile diagnostic (WPD) method. Such a WPD method includes the use of an input DTD, which can specifically include (for example, as noted above) parameters representing the DTD in the WPC areas of interest (for example, FA, EA, CZ, AR, AS, LZ, RI, and SI). Accordingly, a WPD method can include the following steps. The group of tickets corresponding to the service pool being analyzed in a certain period of time is selected. The ticket distribution in the denoted area(s) of interest is computed, and the DTD is compared to the computed ticket distribution for each area.

If the absolute difference between the desired and the actual distribution is greater than 100% of the desired value, flag the area of interest is flagged and/or annotated as a “problem.” If the absolute difference between the desired and the actual distribution is between 50% and 100% of the desired value, the area of interest is flagged and/or annotated as an “issue.” For each identified “problem” and/or “issue,” at least one embodiment of the invention includes verifying to which of the denoted areas of interest the “problem” and/or “issue” belongs, and the characterization is applied to the system or relevant component.

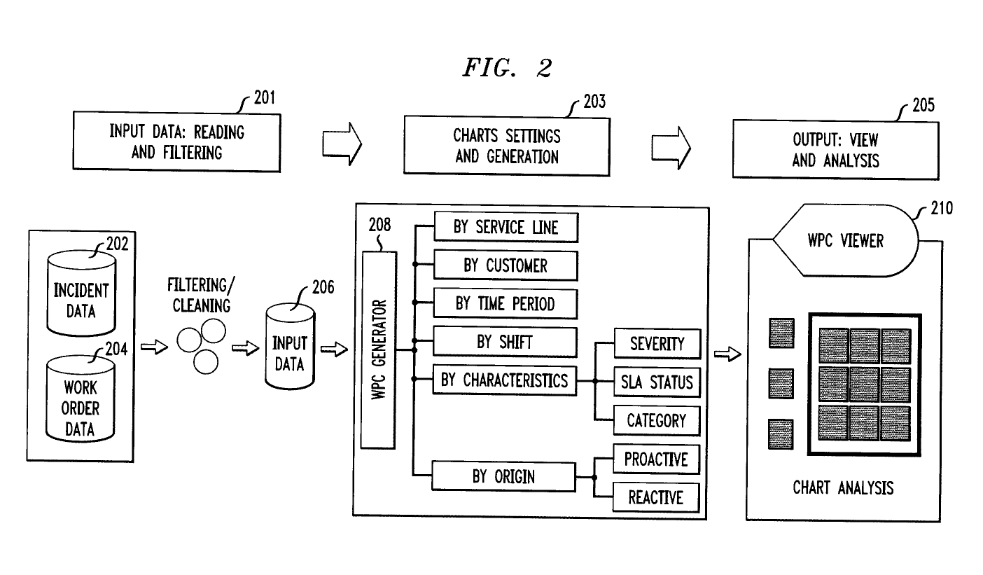

FIG. 2 is a block diagram illustrating an example embodiment, according to an aspect of the invention. By way of illustration, FIG. 2 depicts tools utilized to deploy WPC and WPD via steps of reading and filtering input data (step 201), data generation (step 203) and data analysis and output (step 205). As illustrated, incident data 202 and work order data 204 are filtered to produce input data 206. In at least one embodiment of the invention, the data are filtered to remove incomplete records/fields (that is, records with missing data that cannot be completed). The input data 206 are provided to a WPC generator component 208 which generates the charts (which contain information about a concentration of tickets in each specified area) to be analyzed and view via the WPC viewer component 210.

The components depicted in FIG. 2 can be implemented as an analytics tool for incident management to characterize the performance of service delivery workload profiles, as well as to identify productivity and service quality issues (such as map transformation impacts, diagnose of delivery problems, etc.). The output (that is, the generated chart) depicts the concentration of tickets in certain areas and, depending on how and where the concentration is distributed, different diagnoses may be performed such as, for example, identifying quality issues, identifying the impact of interventions performed in the past or opportunities of improvements, etc.

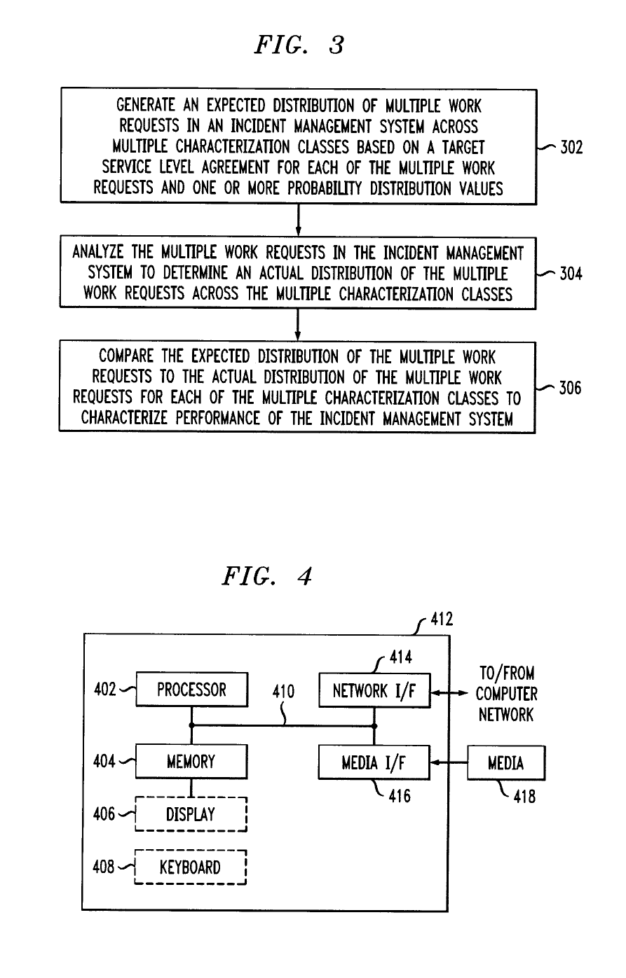

FIG. 3 is a flow diagram illustrating techniques according to an embodiment of the present invention. Step 302 includes generating an expected distribution of multiple work requests in an incident management system across multiple characterization classes based on a target service level agreement for each of the multiple work requests and one or more probability distribution values (for example, a log-normal distribution value). As detailed herein, the characterization classes can include a false alarm characterization, an excess availability characterization, a comfort zone characterization, an adequate resources characterization, an adequate skills characterization, a limit zone characterization, a resource issue characterization, and/or a skill issue characterization. Also, the target service level agreement can include a target percentage value for the sum of the work request percentile of a characterization class of interest.

The generating step can additionally be based on one or more statistical parameters, such as mean and standard deviation of assignment delay and resolution time variables.

Step 304 includes analyzing the multiple work requests in the incident management system to determine an actual distribution of the multiple work requests across the multiple characterization classes. The analyzing step can include determining an assignment delay and a resolution delay for each of the multiple work requests. Also, characterizing performance of the incident management system can include identifying an opportunity for automated resolution and/or automated assignment of a work request, as well as identifying an opportunity for an increases or a decrease in a resource within the incident management system. Further, characterizing performance can additionally include denoting a given characterization class as an issue based on a specified deviation between the expected distribution of the multiple work requests to the actual distribution of the multiple work requests for the given characterization class.

Step 306 includes comparing the expected distribution of the multiple work requests to the actual distribution of the multiple work requests for each of the multiple characterization classes to characterize performance of the incident management system. At least one embodiment of the invention can also include producing a visual representation based on said comparing the expected distribution of the multiple work requests to the actual distribution of the multiple work requests for each of the multiple characterization classes. By way of example, the visual representation can include a plot of the work request data corresponding to the above-noted comparing step on a log-log chart.

Characterizing performance of the incident management system can include annotating a characterization class as a problem if the absolute difference between the expected distribution and the actual distribution is greater than 100% of the expected distribution value for the characterization class. Further, characterizing performance of the system can include annotating a characterization class as an issue if the absolute difference between the expected distribution and the actual distribution is between 50% and 100% of the expected distribution value for the characterization class.

The techniques depicted in FIG. 3 can also include receiving the multiple work requests into the incident management system, each work request having a time-to-service requirement. Additionally, the multiple work requests can correspond to a certain period of time.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and configured to perform exemplary method steps.

Additionally, an aspect of the present invention can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, radio frequency (RF), etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, identifying classes of problems for automated resolution and/or assignment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An article of manufacture comprising a computer readable storage medium having computer readable instructions tangibly embodied thereon which, when implemented, cause a computer to carry out a plurality of method steps comprising:
generating an expected distribution of multiple work requests in an incident management system across multiple characterization classes based on a target service level agreement for each of the multiple work requests and one or more probability distribution values;
analyzing the multiple work requests in the incident management system to determine an actual distribution of the multiple work requests across the multiple characterization classes; and
comparing the expected distribution of the multiple work requests to the actual distribution of the multiple work requests for each of the multiple characterization classes to characterize performance of the incident management system.

2. The article of manufacture of claim 1, wherein said multiple characterization classes comprises one or more of a false alarm characterization, an excess availability characterization, a comfort zone characterization, an adequate resources characterization, an adequate skills characterization, a limit zone characterization, a resource issue characterization, and a skill issue characterization.

3. The article of manufacture of claim 1, wherein said one or more probability distribution values comprise a log-normal distribution value.

4. The article of manufacture of claim 1, wherein said generating is further based on one or more statistical parameters.

5. The article of manufacture of claim 4, wherein said one or more statistical parameters comprise mean and standard deviation of assignment delay and resolution time variables.

6. The article of manufacture of claim 1, wherein said target service level agreement comprises a target percentage value for the sum of the work request percentile of a characterization class of interest.

7. The article of manufacture of claim 1, wherein said analyzing comprises determining an assignment delay and a resolution delay for each of the multiple work requests.

8. The article of manufacture of claim 1, wherein said characterizing performance of the incident management system comprises identifying an opportunity for automated resolution and/or automated assignment of a work request.

9. The article of manufacture of claim 1, wherein said characterizing performance of the incident management system comprises identifying an opportunity for an increases or a decrease in a resource within the incident management system.

10. The article of manufacture of claim 1, wherein said characterizing performance of the incident management system comprises denoting a given characterization class as an issue based on a specified deviation between the expected distribution of the multiple work requests to the actual distribution of the multiple work requests for the given characterization class.

11. The article of manufacture of claim 1, wherein the method steps comprise:
receiving the multiple work requests into the incident management system, each work request having a time-to-service requirement.

12. The article of manufacture of claim 1, wherein the multiple work requests correspond to a certain period of time.

13. The article of manufacture of claim 1, wherein the method steps comprise:
producing a visual representation based on said comparing the expected distribution of the multiple work requests to the actual distribution of the multiple work requests for each of the multiple characterization classes.

14. The article of manufacture of claim 13, wherein said visual representation comprises a plot of the work request data corresponding to said comparing step on a log-log chart.

15. The article of manufacture of claim 1, wherein said comparing the expected distribution to the actual distribution to characterize performance of the incident management system comprises annotating a characterization class as a problem if the absolute difference between the expected distribution and the actual distribution is greater than 100% of the expected distribution value for the characterization class.

16. The article of manufacture of claim 1, wherein said comparing the expected distribution to the actual distribution to characterize performance of the incident management system comprises annotating a characterization class as an issue if the absolute difference between the expected distribution and the actual distribution is between 50% and 100% of the expected distribution value for the characterization class.

17. A system comprising:
a memory; and
at least one processor coupled to the memory and configured for:
generating an expected distribution of multiple work requests in an incident management system across multiple characterization classes based on a target service level agreement for each of the multiple work requests and one or more probability distribution values;
analyzing the multiple work requests in the incident management system to determine an actual distribution of the multiple work requests across the multiple characterization classes; and
comparing the expected distribution of the multiple work requests to the actual distribution of the multiple work requests for each of the multiple characterization classes to characterize performance of the incident management system.

18. The system of claim 17, wherein said multiple characterization classes comprises one or more of a false alarm characterization, an excess availability characterization, a comfort zone characterization, an adequate resources characterization, an adequate skills characterization, a limit zone characterization, a resource issue characterization, and a skill issue characterization.

19. The system of claim 17, wherein said one or more probability distribution values comprise a log-normal distribution value.

20. The system of claim 17, wherein said analyzing comprises determining an assignment delay and a resolution delay for each of the multiple work requests.
